(19) United States
(12) Patent Application Publication
(10) Pub. No.: US 2009/0282194 A1
(43) Pub. Date: Nov. 12, 2009

(54) Removable storage accelerator device

(76) Inventor: Masashi Nagashima, Tokyo (JP)

Correspondence Address: Kelly P. Fitzgerald;Shumaker & Sieffert, P.A., Suite 300, 1625 Radio Drive, Woodbury, MN, 55125, US

(21) Appl. No.: 12/151,563

(22) Filed: May 7, 2008

(51) Int. Cl. G06F 12/06; G06F 12/02; G06F 13/20; G06F 12/00

(52) U.S. Cl. 711/115; 710/313; 711/105; 711/103; 711/E12.008; 711/E12.083

(57) ABSTRACT

An accelerator device including a cache memory, a controller that is electrically coupled to the cache memory, a host computer connecter that is electrically coupled to the controller, and a removable storage device connector that is electrically coupled to the controller. The accelerator device can be electrically coupled to a host computer via the host computer connector. The accelerator device can also be electrically coupled to a removable storage device via the removable storage device connector. When the accelerator device is electrically coupled to the host computer and the removable storage device is electrically coupled to the accelerator device, the controller caches data sent from the host computer to the removable storage device in the cache memory prior to the data being sent from the accelerator device to the removable storage device.

### TECHNICAL FIELD

The invention relates to removable storage devices and, in particular, devices for use with removable storage devices.

### BACKGROUND

A wide variety of removable storage devices exist for use with voice recorders, digital video camcorders, digital cameras, personal digital assistants (PDAs), cellular phones, video games, digital televisions, photo printers, and the like. The removable storage devices can allow users to capture and store data on such devices, and easily transport the data between these devices and host computers. In addition, removable storage media devices can be used to backup data from a host computer or to transport data from a host computer to another device by transferring data contained on the host computer to the removable storage device.

One of the most popular types of removable storage devices utilizes flash memory, such as flash memory cards and flash memory drives, which are compact, easy to use, and have no moving parts. A flash memory card or drive includes an internal, high-speed solid-state memory capable of persistently storing data without application of power. A wide variety of flash memory cards have been recently introduced, each having different capacities, access speeds, formats, interfaces, and connectors. Examples of flash memory cards include CompactFlash (CF) first introduced by SanDisk Corporation, the Memory Stick (MS) and subsequent versions including Memory Stick Pro and Memory Stick Duo developed by Sony Corporation, Smart Media memory cards, Secure Digital (SD) memory cards, and MultiMedia Cards (MMCs) jointly developed by SanDisk Corporation and Siemens AG/Infineon Technologies AG, and xD digital memory cards developed by Fuji. Many other flash memory card standards continue to emerge and evolve.

Another type of removable storage device utilizes hard disk memory, such as hard disk cartridges, zip disks, and external portable hard disk drives. Unlike flash memory, hard disk memory devices generally include moving parts to read or write data to the memory. For example, portable hard disk memory devices typically include one or more rotating magnetic disks and one or more transducer heads that move radially relative to the rotating magnetic disks. Examples of removable storage devices utilizing hard disk memory include, but are not limited to commercially available HDD products, such as, e.g., REV developed by IOMEGA Corp. of San Diego, Calif.; GoVault by Quantum of San Diego, Calif.; RDX by Prostor Systems, Inc. of Boulder, Colo.; Odyssey by Imation of Oakdale, Minn.; and iVDR by iVDR Consortium.

Numerous other types of memory can also be used in removable storage devices, including electrically-erasable-programmable-read-only-memory (EEPROM), non-volatile random-access-memory (NVRAM), and other non-volatile memory types. Volatile memory types, such as dynamic random-access-memory (DRAM) and synchronous dynamic random-access-memory (SDRAM), can also be used although volatile memory types require power to store data.

Removable storage devices typically include a unique connector, which defines the electrical and mechanical interfaces of the device. In some cases, the connector associated with a removable storage device allows the device to be directly connected to a host computer to transfer data. For example, a flash drive typically includes a male USB connector that may be connected directly to a host computer's corresponding female USB connector. In other cases, however, the removable storage media devices may require a specialized adapter or reader in order to be read by a host computer. The adapter or reader may include a specialized connector that conforms to that of the removable storage device, but may also include a host connector configured to be accepted by a host computer. In this way, an adaptor or reader can allow a host computer to read data from and write data to a removable storage device that cannot otherwise connect to the host computer.

In some cases, a host computer is able to send data to a removable storage device at a transfer rate that exceeds the rate in which data can be written to the removable storage device. Consequently, the time required to complete the transfer of data from a host computer to a removable storage device is limited by the rate the data can be written to the removable storage device. Moreover, if the removable storage device is disconnected from the host computer before all the data from the host computer is written to the storage media, then a portion of the data intended to be transferred may not be successfully stored on the removable storage device. Accordingly, to ensure that all the data is successfully transferred from the host computer to a removable storage device, a removable storage device must typically be connected to a host computer for extended periods of time.

### SUMMARY

In general, the invention is related to devices, systems and methods that may be utilized to transfer data between a host computer and a removable storage device. For example, in some embodiments, a host computer and a removable storage device may be electrically coupled via an accelerator device. Accordingly, data may be transferred between the host computer and the removable storage device via the accelerator device. The accelerator device may contain a cache memory that caches data sent from the host computer to the removable storage device prior to the data being sent from the accelerator device to the removable storage device.

In one embodiment, the invention is directed to a device comprising a cache memory; a controller electrically coupled to the cache memory; a host computer connecter electrically coupled to the controller, wherein the accelerator device can be electrically coupled to a host computer via the host computer connector; and a removable storage device connector electrically coupled to the controller, wherein a removable storage device can be electrically coupled to the accelerator device via the removable storage device connector, wherein when the accelerator device is electrically coupled to the host computer and the removable storage device is electrically coupled to the accelerator device, the controller caches data sent from the host computer to the removable storage device in the cache memory prior to the data being sent from the accelerator device to the removable storage device.

In another embodiment, the invention is directed to a method comprising coupling an accelerator device to a host computer, the device comprising a cache memory; a controller electrically coupled to the cache memory; a host computer connecter electrically coupled to the controller, wherein the accelerator device can be electrically coupled to the host computer via the host computer connector; and a removable storage device connector electrically coupled to the controller, wherein a removable storage device can be electrically coupled to the accelerator device via the removable storage device connector; coupling the removable storage device to the accelerator device via the removable memory device interface; and transferring data from the host computer to the removable storage media device via the accelerator device, wherein the controller caches data sent from the host computer to the removable storage device in the cache memory prior to the data being sent from the accelerator device to the removable storage device.

In another embodiment, the invention is directed to a system comprising a removable storage device; and an accelerator device, the accelerator device comprising: a cache memory; a controller electrically coupled to the cache memory; a host computer connecter electrically coupled to the controller, wherein the accelerator device can be electrically coupled to a host computer via the host computer connector; and a removable storage device connector electrically coupled to the controller, wherein the removable storage device can be electrically coupled to the accelerator device via the removable storage device connector, wherein when the accelerator device is electrically coupled to the host computer and the removable storage device is electrically coupled to the accelerator device, the controller caches data sent from the host computer to the removable storage device in the cache memory prior to the data being sent from the accelerator device to the removable storage device.

Embodiments of the present invention may provide for one or more advantages. For example, in some embodiments, an accelerator device may include a cache memory that allows data to be cached at a speed that is greater than the speed that the data can be written to the removable storage device from the host computer. Accordingly, the time required to successfully transfer data from a host computer to the accelerator device may be less than that required to transfer data from the host computer directly to the removable storage media device.

As another example, in some embodiments, an accelerator device may include a power source that provides energy for the accelerator device to operate. Accordingly, the power source may allow an accelerator device to send data to a removable storage device without requiring power from an external source, e.g., a host computer.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a functional block diagram illustrating an exemplary accelerator device according to an embodiment of the present invention.

FIG. 2 is a schematic diagram illustrating an exemplary system according to an embodiment of the present invention.

FIG. 3 is a functional block diagram illustrating an exemplary accelerator device according to an embodiment of the present invention.

FIG. 4 is a schematic diagram illustrating an exemplary accelerator device according to an embodiment of the present invention.

FIG. 5 is a flow chart illustrating an exemplary method according to an embodiment of the present invention.

FIG. 6 is a flow chart illustrating another exemplary method according to an embodiment of the present invention.

### DETAILED DESCRIPTION

In some embodiments, the present invention relates to an accelerator device that may be used to electrically couple a removable storage device to a host computer such that data may be transferred between the removable storage media device and the host computer via the accelerator device. The accelerator device may include a removable storage device connector, a host computer connector, and cache memory. The connectors allow the accelerator device to be electrically coupled to a removable storage device and a host computer, respectively. Data may be transferred between the host computer and the removable storage device via the accelerator device when the accelerator device is electrically coupled to a removable storage device and a host computer. Data sent by a host computer to the removable storage device may be cached in the cache memory of the accelerator device prior to being sent from the accelerator device to a removable storage device.

The removable storage device connector and host computer connector may be removably connected to the accelerator device. Accordingly, the accelerator device is not limited to use with a single removable storage device or to a single host computer. Rather, a user may connect and disconnect different individual removable storage devices to the accelerator device, and may couple the accelerator device to different host computers.

In some embodiments, the accelerator device allows data sent from a host computer to be written to a cache memory of the accelerator device at a speed that is greater than the speed that the data can be written to the removable storage device from the host computer. Accordingly, the time required to successfully transfer data from a host computer to the accelerator device may be less than that required to transfer data from the host computer directly to the removable storage media device. The accelerator device may store such data temporarily until such data is accurately transferred to the removable storage media device. Accordingly, the combination of the removable storage media device and the accelerator device may allow users to seemingly transfer data from the host computer and the removable storage media device at the improved data transfer rate associated with the accelerator device.

Further, in some embodiments, an accelerator device may include a power source that supplies sufficient energy to operate the accelerator device without requiring additional energy from an external source, such as a host computer. For example, a power source of an accelerator device may store an amount of voltage that is sufficient to allow the controller to send cached data from the cache memory of the accelerator device to a removable storage device without an additional supply of voltage from an external device. Accordingly, data may be sent from the accelerator device to a removable storage device without requiring power from the host computer. In some cases, the internal power source may allow an accelerator device to be decoupled from a host computer prior to all of the data being successfully written to the removable storage device because the accelerator device is able to successfully send the cached data in the cache memory to the removable storage device without requiring additional power from the host computer. Additionally, the power source may provide a primary or back-up source of voltage in an accelerator device that utilizes volatile memory, e.g., DRAM or SDRAM, as cache memory to allow for data to be stored on the cache memory without requiring an external power source, such as a host computer.

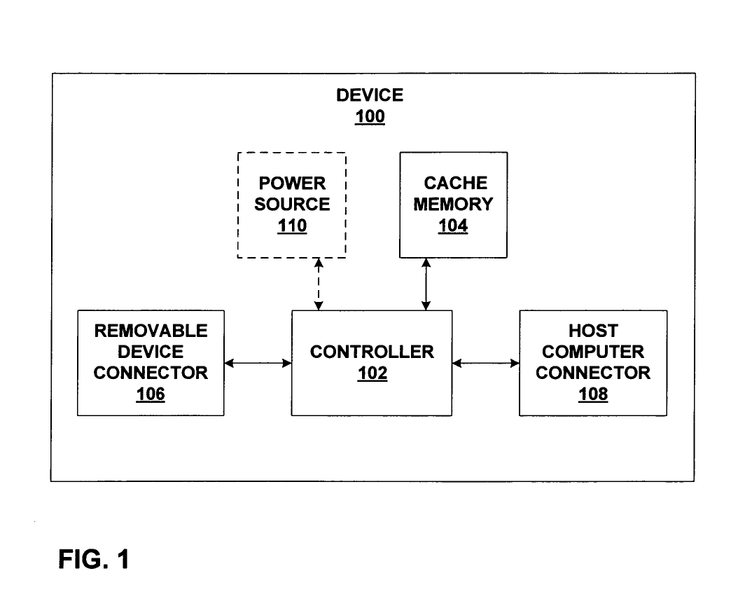

FIG. 1 is a functional block diagram illustrating exemplary accelerator device 100 according to an embodiment of the invention. Accelerator device 100 includes a controller 102, a cache memory 104, a removable storage device connector 106 and a host computer connector 108. As illustrated by FIG. 1, controller 102 is electrically coupled to removable storage device connector 106 and also electrically coupled to host computer connector 108. Therefore, removable storage device connector 106 and host computer connector 108 are electrically coupled via controller 102. Furthermore, controller 102 is electrically coupled to cache memory 104. Accordingly, removable storage device connector 106 may be also electrically coupled to cache memory 104 via controller 102, and host computer connector 108 may be electrically coupled to cache memory 104 via controller 102. In some embodiments, device 100 may optionally include power source 110, as indicated by the dashed lines in FIG. 1. As shown, power source 110 may be electrically coupled to controller 102. Accordingly, power source 110 may also be electrically coupled to cache memory 104, host computer connecter 108, and removable storage device connector 106, via controller 102.

Removable storage device connector 106 is configured to connect to a removable storage device (not shown). The removable storage device may include a connector that conforms to same connector standard associated with removable storage device connector 106, which allows the removable storage device to be electrically coupled to accelerator device 100 via removable storage device connector 106. For example, removable storage device connector 106 may conform to a connector standard associated with a removable storage device such as a Compact Flash standard, a Smart Media standard, a MultiMedia Card standard, a Secure Digital standard, a Memory Stick standard, an xD standard, a Universal Serial Bus (USB) standard, a Universal Serial Bus 2 (USB 2) standard, a Small Computer System Interface (SCSI) standard, Serial Attached SCSI (SAS), an Advance Technology Attachment (ATA) standard, and a serial ATA (SATA) standard. In other cases, removable storage device connector 106 may conform to a specially designed standard that may be unique to the specific type of device. In any case, when electrically coupled via device connector 106, data may be transferred between accelerator device 100 and the connected removable storage device.

Host computer connector 108 is configured to connect to a host computer port conforming to the same connector standard as the host computer connector 108 to couple the host computer to accelerator device 100. For example, host computer connector 108 may conform to a connector standard associated with a host computer such as personal computer memory card international association (PCMCIA) standard, PC Card standard, a CardBus standard, a Universal Serial Bus (USB) standard, a Universal Serial Bus 2 (USB2) standard, an IEEE 1394 FireWire standard, a Small Computer System Interface (SCSI) standard, Serial Attached SCSI (SAS), an Advance Technology Attachment (ATA) standard, a serial ATA (SATA) standard, a Peripheral Component Interconnect (PCI) standard, and a conventional serial or parallel standard. By connecting a host computer to accelerator device 100 via host computer connector 108, a host computer may be electrically coupled to accelerator device 100. When electrically coupled via host computer connector 108, data may be transferred between accelerator device 100 and the connected host computer.

Accordingly, as indicated by FIG. 1, device 100 may be electronically coupled to both a removable storage device and a host computer at the same time. Such a configuration allows a removable storage device to be electronically coupled to a host computer via accelerator device 100. Consequently, data may be transferred between the host computer to the removable storage device via accelerator device 100. For example, when a host computer and removable storage device are both connected to accelerator device 100, data that is stored on a host computer may be sent by the host computer to a removable storage device via accelerator device 100. Accelerator device 100 receives the data sent by the host computer, which can be sent from accelerator device 100 to the removable storage device. When the data is received by the removable storage device, it is written to the storage medium of the removable storage device.

Controller 102 controls data received from a host computer or removable storage device that is coupled to accelerator device 100 via host connector 108 or removable storage device connector 106, respectively. In some embodiments, controller 102 controls data received from a host computer so that the data is cached in cache memory 104 prior to sending that data to a removable storage device via removable device connector 106. In such cases, controller 102 also controls data contained in cache memory 104 to be sent to a removable storage device that is coupled to accelerator device 100 via removable storage device connector 106. In some embodiments, controller 102 may control data received from a host computer so that it is sent directly to a removable storage device via removable storage device connector 106 without caching the data in cache memory 104.

Accelerator device 100 uses cache memory 104 to cache data received from a host computer that is electrically coupled to device 100 via host computer connecter 108. As previously explained, controller 102 may control data received by device 100 from a host computer to be cached in cache memory 104 prior to being sent to a removable storage device via removable device connector 106. Cache memory 104 may include any suitable memory capable of temporarily storing data received by accelerator device 100 and may suitably function as a write cache memory, read cache memory or both. For example, cache memory 104 may be flash memory, dynamic random access memory (DRAM), or synchronous dynamic random access memory (SDRAM).

The maximum amount of data that may be cached to cache memory 104 can vary according to embodiments of the invention. For example, in some embodiments the maximum amount of data that can be stored to cache memory 104 may range from approximately 8 megabytes to approximately 4 gigabytes, such as approximately 64 megabytes to approximately 2 gigabytes. In some embodiments, the maximum amount of data that can be cached to cache memory 104 may be suitable to function substantially as described herein.

Further, the maximum amount of data that can be cached to cache memory 104 may vary with respect to the storage capacity of a removable storage device. In some embodiments, the maximum amount of data that can be stored to cache memory 104 may range from approximately 0.1 percent to approximately 25 percent of the maximum capacity of the primary memory of a removable storage device. However, as accelerator device 100 may be utilized with multiple individual removable storage devices which may have different storage capacities, in some cases, the capacity of cache memory with respect to the maximum capacity of the primary memory of a removable storage device can vary depending on the respective removable storage device. For example, in some embodiments, the maximum capacity of cache memory 104 may be less than the maximum capacity of a first removable storage device, while also being equal to a greater than the maximum capacity of a second removable storage device. In some cases, the capacity of a cache memory may be limited by economic reasons.

In general, the speed that data can be written to a memory varies between the different types of memory. For example, data typically may be written to flash memory, DRAM, and SDRAM at a higher speed than that of a hard disk. Moreover, data typically may be written to DRAM and SDRAM at a higher speed than flash memory. Consequently, the speed at which data is cached by accelerator 100 depends on the type of memory used for cache memory 104. Similarly, the speed at which data may be written to a removable storage device also depends on the type of memory used in the removable storage device. For example, data sent from a host computer may be written to a removable storage device having flash memory at a higher speed than to a removable storage device having hard disk memory. In some cases, for example, the speed that data may be written to hard disk memory may range from about 40 to about 80 megabytes per second, depending on the recording density, rotation speed and connection interface; the speed that data may be written to flash memory may range from about 40 to about 130 megabytes per second; and the speed that data may be written to DRAM and SDRAM may be greater than about 100 megabytes per second.

As described previously, the speed at which a host computer can send data to a removable storage device is typically greater than the speed that the data may be written to the removable storage device. In such cases, the time required for data to be successfully transferred from a host computer to a removable storage device is primarily limited by the speed that the data may be written to the removable device. Furthermore, the host computer is required to be electrically coupled to the removable storage device throughout the entire time required to write the data to removable storage device, even though the host computer could transfer the data in a shorter amount of time.

Consequently, in some embodiments, accelerator device 100 utilizes a type of memory for cache memory 104 that allows accelerator device 100 to cache data sent from a host computer at a higher speed than the same data can be written to a removable storage device from the host computer. For example, accelerator device 100 may include removable storage device connector 106 that is configured to connect to a hard disk cartridge, which utilizes hard disk memory. In such cases, cache memory 104 of accelerator device 100 may be any type of memory that allows data sent from a host computer to be cached at a speed greater than the data can be written to the hard disk cartridge, e.g., flash memory, DRAM or SDRAM.

As another example, accelerator device 100 may include removable storage device connector 106 that is configured to connect to an xD memory card, which utilizes flash memory. In such cases, cache memory 104 of accelerator device 100 may be any type of memory that allows data sent from a host computer to be cached at a speed greater than the data can be written to the xD memory card, e.g., DRAM or SDRAM. In such embodiments, accelerator 100 may receive data sent from an electrically coupled host computer to be stored on the removable storage device also electrically coupled to accelerator device 100. Accelerator device 100 caches the data received from the host computer in cache memory 104. After caching the data, accelerator device 100 sends the data from cache memory 104 to the removable storage device. As a result, data sent from the host computer may be written to the combination of accelerator device 100 and an electrically coupled removable storage device in a shorter amount of time than the data could be written directly to the removable storage device.

When electrically coupled to a host computer via host computer connector 108, accelerator device 100 can receive energy from the host computer to operate as described herein. For example, accelerator device 100 may be connected to a host computer via a USB connection which permits accelerator device 100 to receive a voltage from the host computer. Similarly, other connection standards besides USB connections can allow voltage to be supplied from a host computer to an electrically coupled accelerator device 100. In general, the energy supplied by an electrically coupled host computer to accelerator device 100 may be used by accelerator device 100 to operate substantially as described herein.

Notwithstanding the ability to receive power from a source computer, as illustrated by FIG. 1, accelerator device 100 may optionally include power source 110. Power source 110 may provide an amount of energy that can be used to operate accelerator device 100. In some embodiments, power source 110 provides a sufficient amount of energy to operate accelerator device 100 as described herein without the requiring additional energy from a host computer. For example, power source 110 may provide energy to maintain cached data in embodiments in which cache memory 104 is a volatile memory type such as DRAM or SDRAM. Power source 110 may also provide energy to transfer data that is cached on cache memory 104 to a removable storage device without requiring additional energy from a host computer. For example, power source 110 may store an amount of voltage sufficient to send the maximum amount of data capable of being cached on cache memory 104 to a removable storage device. As such, power source 110 may allow for a host computer to be decoupled from accelerator device 100 before all the data sent from the host computer is written to the removable storage device.

Accordingly, power source 110 may include any suitable components that may be configured to supply energy to accelerator device 100 as described above. For example, power source 110 may include an uninterruptible power supply (UPS). In some embodiments, a UPS may include one or more capacitors to provide energy to accelerator device 100. The one or more capacitors may be capable of storing an amount of voltage sufficient to allow controller 102 to send an amount of data stored in memory cache 104 to a removable storage media device when accelerator device 100 is decoupled from the host computer. As another example, power source 110 may include one or more batteries to provide energy to accelerator device 100. In some embodiments, one or more batteries may provide all or a portion of the energy required to operate accelerator device 100 without requiring additional energy from a host computer.

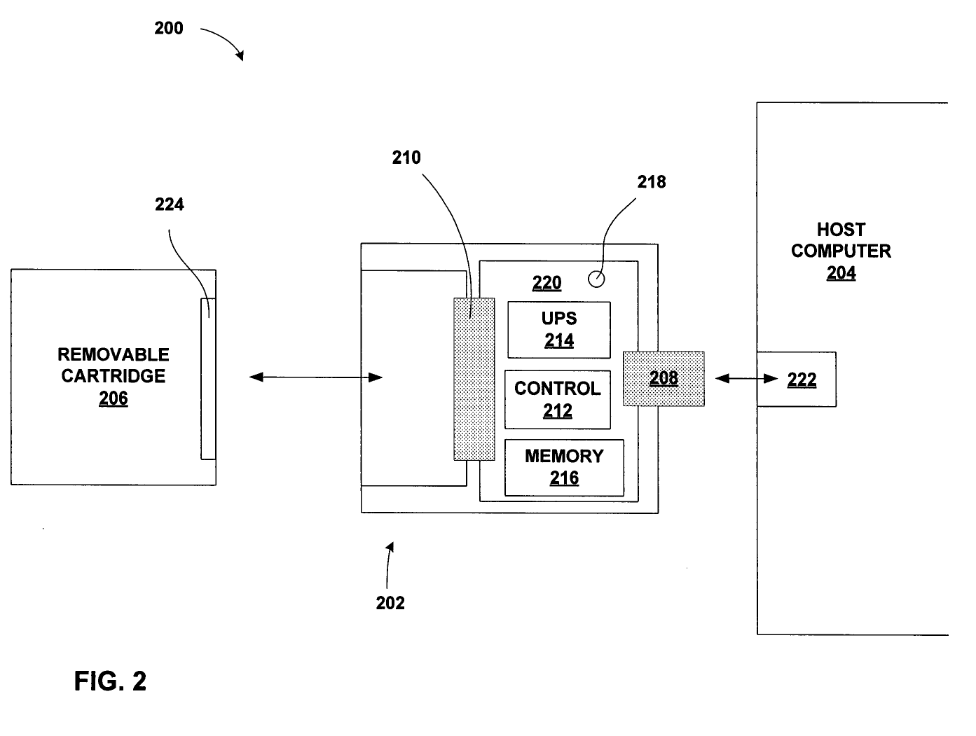

FIG. 2 is a schematic diagram illustrating an exemplary system 200 according to an embodiment of the present invention. System 200 includes an accelerator device 202, a host computer 204 having a host computer port 222 and a removable storage device 206, which is shown as a removable hard disk cartridge 206 having a cartridge connector 224.

Accelerator device 202 includes host connector 208, removable storage device connector 210, controller 212, cache memory 216, and power source 214, all of which are consistent with the corresponding features described with respect to FIG. 1. In addition, accelerator device 202 also includes an indicator element 218 and a printed circuit board 220 on which connectors 208 and 210, controller 212, cache memory 216, power source 214 and indicator element 218 are provided.

As illustrated by FIG. 2, accelerator device 202 may be removably connected to both host computer 204 and removable cartridge 206. Consequently, data may be transferred from host computer 204 to removable cartridge 206 via accelerator device 202. More specifically, as shown, cartridge connector 224 and removable storage device connector 210 conform to a Small Computer System Interface (SCSI) standard. Accordingly, cartridge connector 224 connects to removable storage device connecter 210 to electrically couple hard disk cartridge 206 and accelerator device 202. By electrically coupling the accelerator device 202 to hard disk cartridge 206 via device connector 210 and cartridge connecter 224, data may be transferred between accelerator device 202 and disk cartridge 206. Unlike cartridge connector 224 and removable storage device connector 210, host computer port 222 and host computer connector 208 conform to the Universal Serial Bus (USB) connector standard. Accordingly, host computer connector 208 may be inserted into host computer port 222 to electrically couple host computer 204 to accelerator device 202. When electrically coupled to one another via connector 208 and port 222, data may be transferred between host computer 204 and accelerator device 202.

Furthermore, electrically coupling host computer 204 and accelerator device 202 via the USB connection allows host computer 204 to supply a voltage to accelerator device 204. Controller 212 controls voltage received from host computer 204 via host computer connecter 208 such that accelerator device 202 operates substantially as described herein. For example, accelerator device 202 may use voltage to cache data received from host computer 204 prior to sending the data to removable hard disk cartridge 206. In addition, accelerator device 202 may provide the voltage to removable hard disk cartridge 206 so that data sent by accelerator device 202 may be written to cartridge 206 memory.

To transfer data from host computer 204 to removable cartridge 206 via accelerator device 202, data is sent from host computer 204 to removable cartridge 206 when they are electrically coupled to one another via accelerator device 202. As configured, the data is first received by accelerator device 202 via host computer connector 208. Controller 212 may cache the data received from the host computer 204 in cache memory 216 prior to the data being sent from accelerator device 202 to removable hard disk cartridge 206. As described previously, an accelerator device can include a type of cache memory that allows data sent from a host computer to be cached at a speed greater than the data can be written to a connected removable storage device from a host computer. In the embodiment illustrated in FIG. 2, cache memory 216 utilizes flash memory such that data sent by host computer 204 may be cached by accelerator device 202 at a higher speed than the data could be written to removable hard disk cartridge 206, which utilizes hard disk memory. By caching the data sent by host computer 204 to removable cartridge 206, the time required for data sent from host computer 204 to be successfully written to the combination of accelerator device 202 and removable hard disk cartridge 206 is less than the time required for the data to be successfully written to removable hard disk cartridge 206 only.

In some embodiments, when accelerator device 202 is electrically coupled to host computer 204 and removable cartridge 206, data may also be sent from removable cartridge 206 to host computer 204 via accelerator device 202, e.g., when host computer 204 reads data stored on removable cartridge 206. As configured in FIG. 2, data sent from removable cartridge 206 is first received by accelerator device 202 via removable storage device connector 210. Controller 212 may cache the data received from removable cartridge 206 in cache memory 216 prior to the data being sent from accelerator device 202 to host computer 204 via host computer connector 208. In this manner, data read by host computer 204 from removable cartridge 206 via accelerator device 202 may be cached in cache memory 216. In some embodiments, accelerator device 202 may include a type of cache memory 216 that allows cached data to be read by host computer 204 at a speed greater than host computer 204 can read data from removable cartridge 206.

Although voltage supplied by host computer 204 to accelerator device 202 can be sufficient to operate accelerator device 202 substantially as described herein, as shown in FIG. 2, accelerator device 202 may further include power source 214, which is coupled to controller 212. In the embodiment shown, power source 214 may be further classified as an uninterruptible power supply (UPS) 214. In general, UPS 214 can provide sufficient energy to operate accelerator device 202 without requiring additional energy from host computer 204. However, in some embodiments, UPS 214 is used primarily as a back-up or supplemental power source that can be used in situations when the power supply from host computer 204 is terminated, e.g., as a result of a power failure to host computer 204 or accelerator device 202 being decoupled from host computer 204, or not capable of supplying sufficient voltage by itself for accelerator device 202 to operate. For example, UPS 214 may provide sufficient energy to operate accelerator device 202 only when additional energy from host computer 204 is terminated.

Consequently, UPS 214 prevents data, which has been received by accelerator device 202 from host computer but not yet sent from accelerator device 202 to removable hard disk cartridge 206, from being lost as a result of the data not being successfully stored on removable hard disk cartridge 206. In such situations, UPS 214 may provide sufficient voltage to allow the controller 212 to send the data cached in cache memory 216 to removable hard disk cartridge 206, including supplying any voltage that may be required to write the data to hard disk cartridge 206. In addition, although memory cache 216 utilizes flash memory, i.e., non-volatile memory, which can store cached data without power, UPS 214 may also be used to supply voltage to a cache memory that utilizes SDRAM and/or DRAM, i.e., volatile memory, to store cached data even after the power supply from a host computer has been terminated.

In some embodiments, UPS 214 may be utilized by accelerator device 202 to allow host computer 204 to be decoupled from accelerator device 202 prior to all the data sent from host computer 204 being successfully written to removable hard disk cartridge 206. For example, host computer 204 may be electrically coupled to accelerator device 202 and removable cartridge 206 to send data to removable cartridge 206 via accelerator device 202. As described above, data sent from host computer 204 to removable cartridge 206 may be cached to cache memory 216 by accelerator device 202 prior to accelerator device 202 sending the data to removable cartridge. Accordingly, at a certain point during the data transfer, all of the data intended to be transferred to removable cartridge 206 will have been successfully sent by host computer 204 and stored to the combination of accelerator device 202 and removable cartridge 206, but not all the data will have be written to removable cartridge 206.

More specifically, the entire set of data intended to be transferred will have been sent by host computer 204, and either: 1) a portion of that data set is cached on cache memory 216 and the remaining portion of the data set is already written to removable cartridge 206, or 2) all of the data set is cached on cache memory 216 and none of it has been written to removable cartridge 206. In both scenarios, at this point a user may electrically decouple accelerator device 202 from host computer 204 by disconnecting host computer connector 208 from host port 222. Despite the fact that the user has electrically decoupled host computer 204 from removable storage media 206 as a result of disconnecting host computer 204 from accelerator device 202, the remaining cached data can be sent from accelerator device 202 to removable hard disk cartridge 206 and written to removable hard disk cartridge 206 using only the voltage supplied by UPS 214. Accordingly, by using the voltage supplied by UPS 214, host computer 204 does not need to be electrically connected to removable cartridge 206 and accelerator device 202 for the entire amount of time required for the data to be written to removable hard disk cartridge 206.

By using voltage supplied from UPS 214 to operate accelerator device 202, the amount of voltage stored by UPS 214 may become partially or completely depleted. Accordingly, in addition to the uses of the voltage supplied from host computer 204 to accelerator device 202 described above, in some embodiments, accelerator device 202 may also use the voltage supplied from host computer to recharge UPS 214. For example, UPS 212 may include a capacitor that stores an amount of voltage when fully charged that is sufficient to operate accelerator device 202 without requiring additional voltage from host computer 204. However, when host computer 204 is initially connected to accelerator device 202, the capacitor 214 may not store a sufficient amount of voltage to operate accelerator device 202 independently. Consequently, controller 212 may control the voltage supplied by host computer 204 to accelerator device 202 so that the amount of voltage stored in capacitor 214 is increased to a sufficient amount. At that time, controller 212 may also control the voltage from host computer 204 such that accelerator device 202 may be operated while also increasing the amount of voltage stored in capacitor. Once the amount of voltage stored in capacitor 214 is sufficient to operate accelerator device 202 independent of host computer 204, controller 212 may discontinue the supply of host computer 204 voltage to capacitor 214.

In some embodiments, the location where controller 212 sends data received from host computer 204 is dictated by the amount of voltage stored in UPS 214. As described above, controller 212 may cache data sent from host computer 204 to cache memory 216 prior to sending the data to removable hard disk cartridge 206, or, alternatively, controller 212 may send data sent from host computer 204 directly to removable cartridge without caching the data. For example, in some embodiments, at times when UPS 214 does not store an amount of voltage sufficient to operate accelerator device 202 without requiring additional power from host computer 204, controller 212 does not cache the data received from host computer 204 but instead sends the data directly to removable cartridge 206. Once the amount of voltage stored in UPS 214 meets at threshold level, e.g., an amount of voltage sufficient to independently operate accelerator device 202, control 212 may then cache the data sent from host computer 204 prior to sending the data to removable hard disk cartridge 206. Accordingly, the likelihood of losing data during the transfer from host computer 204 to removable hard disk cartridge 206 via accelerator device 202 may be reduced.

As illustrated by FIG. 2, accelerator device 202 may include an indicator element 218 coupled to controller 212. In general, indicator element 218 indicates one or more conditions of accelerator device 202 or a system using accelerator device 202 to a user. Indicator element 202 may be any suitable element that can indicate to a user the presence of one or more conditions, e.g., a light-emitting diode (LED) and the like. In the embodiment shown in FIG. 2, indicator element 202 indicates to a user when accelerator device 202 may be safely disconnected from host computer 204 and removable hard disk cartridge 206. For example, indicator element 202 may include an LED that illuminates when all of the data sent from host computer 204 to removable hard disk cartridge 206 has been successfully stored to removable cartridge 206. Accordingly, a user may be informed that the transfer process has been completed.

In other embodiments, indicator element 218 may include more than one LED, such as two LEDs. Controller 212 may cause the first LED to be illuminated only when power source 214 does not have sufficient voltage to operate accelerator device 202 independently from host computer 204. Controller 212 may cause the second LED to be illuminated when accelerator device 202 may be disconnected from host computer 204 by a user. For example, this second LED may be illuminated because all of the data from the host computer has been sent and written to removable cartridge 206. Additionally, the second LED may be illuminated because: 1) accelerator device 202 has received all of the data from host computer 204; 2) UPS 214 contains an amount of voltage sufficient to send and write the cached data to removable hard disk cartridge 206, and 3) all of the data is either cached in cache memory 216 and written to removable cartridge 206, but not all the data is not stored on removable cartridge 206. Accordingly, the second LED indicates to a user that accelerator device 202 may be disconnected from host computer 204 even though all of the data sent by host computer 204 has not necessarily been written to removable cartridge 206.

Although FIGS. 1 and 2 illustrate embodiments of accelerator devices having only a single removable storage device connector to connect to a removable storage device, embodiments of the present invention are not limited to only one storage device connector. Instead, in some embodiments, an accelerator device may include more than one storage device connector. Further, each of the storage device connectors may conform to the same connection standard, or, alternatively, one or more removable storage device connectors may conform to different connection standards.

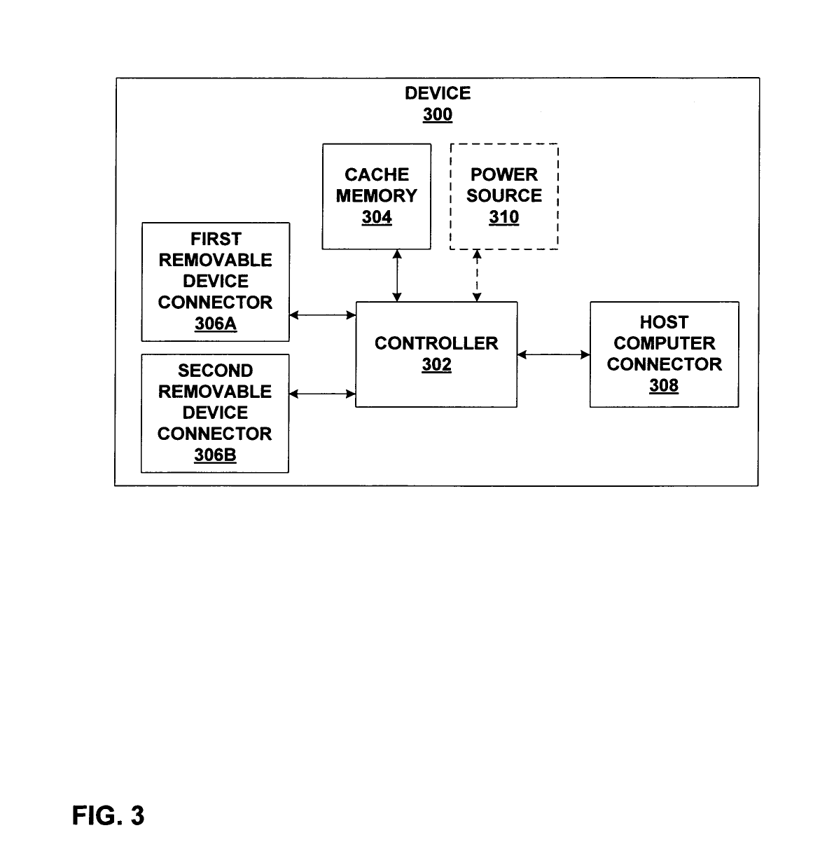

For example, FIG. 3 is a functional block diagram illustrating exemplary accelerator device 300 according to an embodiment of the present invention. Accelerator device 300 includes substantially similar elements as those described with respect to accelerator device 100 except that accelerator device 300 includes first removable storage device connector 306A and second removable storage device connector 306B as opposed to accelerator device 100, which only includes removable device connector 306. Accordingly, accelerator device 300 functions substantially as described with respect to accelerator device 100 except that accelerator device 300 may be connected to two different removable storage devices via first device connector 306A and second device connector 306B. Accordingly, accelerator device 300 may be electrically coupled to storage devices through two separate removable device connectors 306A and 306B. In some embodiments, the two different removable storage devices may be connected to accelerator device 300 via removable device connectors 306A and 306B at the same time. Further, in some embodiments, first removable device connector 306A conforms to a different connection standard than second removable device connector 306B. In such embodiments, accelerator device 300 may connect via first and second removable device connectors 306A and 306B to two different storage devices even though the removable storage device have connectors that conform to different connection standards.

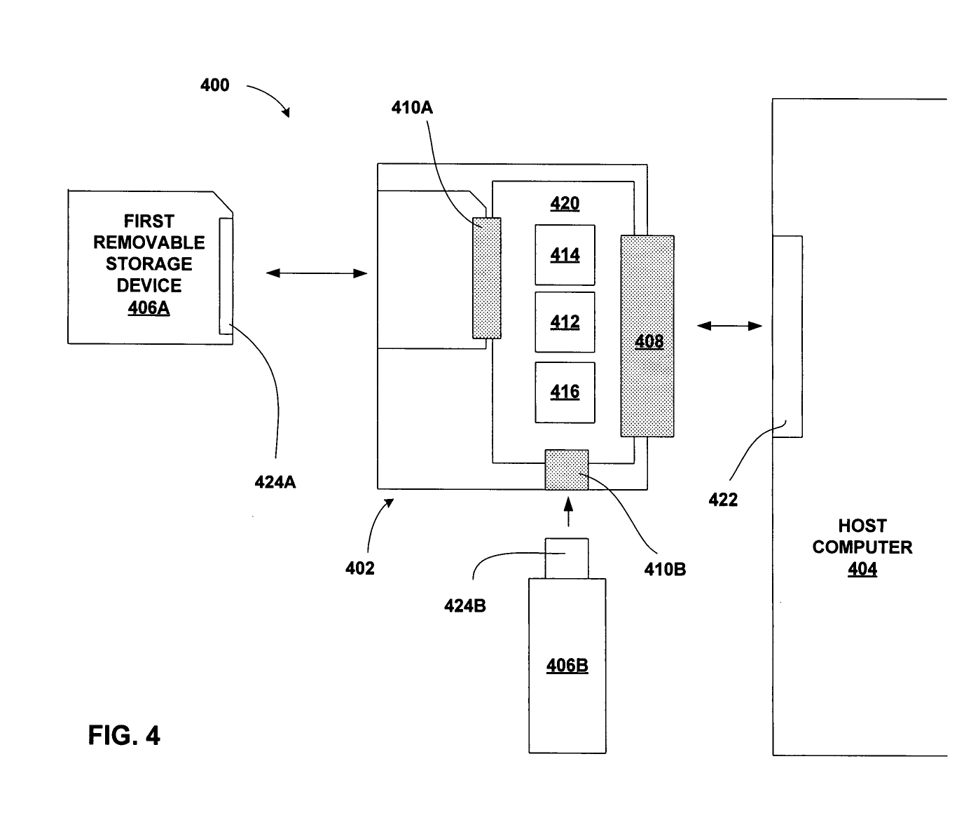

FIG. 4 is a schematic diagram illustrating an exemplary system 400 according to an embodiment of the present invention. As illustrated by FIG. 4, system 400 includes an accelerator device 402, a host computer 404 that includes a host computer port 422, a first removable storage device 406A, and a second removable storage device 406B. First removable storage device 406A is shown as a Secure Digital (SD) flash memory card 406A having card connector 424A. Second removable storage device 406B is shown as a USB flash drive 406B have drive connector 424B.

Accelerator device 402 includes a host connector 408, a first removable storage device connector 410A, a second removable storage device connector 410B, a controller 412, cache memory 414, and a power supply 416, all of which are consistent with the corresponding features described with respect to FIG. 3, and are provided on a printed circuit board 420. In addition, accelerator device 402 functions substantially similar to accelerator device 202 of FIG. 2, except that accelerator device 402 may connect to two different removable storage devices 406A and 406B via connectors 410A and 410B, respectively, as opposed to accelerator device 202, which only has a single removable storage device connector 210.

As illustrated by FIG. 4, accelerator device 402 may be removably connected to host computer 404, flash memory card 406A and USB flash drive 406B. Consequently, data may be transferred from host computer 404 to flash memory card 406A via accelerator device 402, and data may also be transferred from host computer 404 to USB flash drive 406B via accelerator device 402. More specifically, as shown, card connector 424A and first removable storage device connector 410A conform to the Secure Digital connector standard. Accordingly, card connector 424A connects to first removable storage device connecter 410A to electrically couple SD memory card 406A and accelerator device 402. By electrically coupling the accelerator device 402 to SD memory card 406A via first device connector 410A and card connecter 424A, data may be transferred between accelerator device 402 and SD memory card 406A.

Unlike card connector 424A and first removable storage device connector 410A, as shown, drive connector 424B and second removable storage device connector 410B conform to the Universal Serial Bus (USB) connector standard. Accordingly, drive connector 424B may be inserted into second removable storage device connecter 410B to electrically couple flash memory drive 406B and accelerator device 402. By electrically coupling the accelerator device 402 to flash memory drive 406B via second device connector 410B and drive connecter 424B, data may be transferred between accelerator device 402 and flash memory drive 406B.

Furthermore, host computer port 422 and host computer connector 408 conform to the serial ATA (SATA) connector standard. Accordingly, host computer connector 408 may be connected to host computer port 422 to electrically couple host computer 404 to accelerator device 402. When electrically coupled to one another via connector 408 and connector 422, data may be transferred between host computer 404 and accelerator device 402.

SD memory card 406A and USB flash memory drive 406B both utilize flash memory to store data. As described previously, an accelerator device can include a type of cache memory that allows data sent from a host computer to be cached at a speed greater than the data can be written to a connected removable storage device from a host computer. In the embodiment illustrated in FIG. 4, memory cache 414 of accelerator device 402 utilizes DRAM such that data sent by host computer 404 may be cached by accelerator device 402 at a higher speed than the data could be written to SD memory card 406A or USB flash drive 406B. By caching the data sent by host computer 404 to SD memory card 406A or flash drive 406B, the time required for data sent from host computer 404 to be successfully written to the combination of accelerator device 404 and SD memory card 406A or USB flash drive 406B is less than the time required for the data to be successfully written to only SD memory card 406A or USB flash drive 406B.

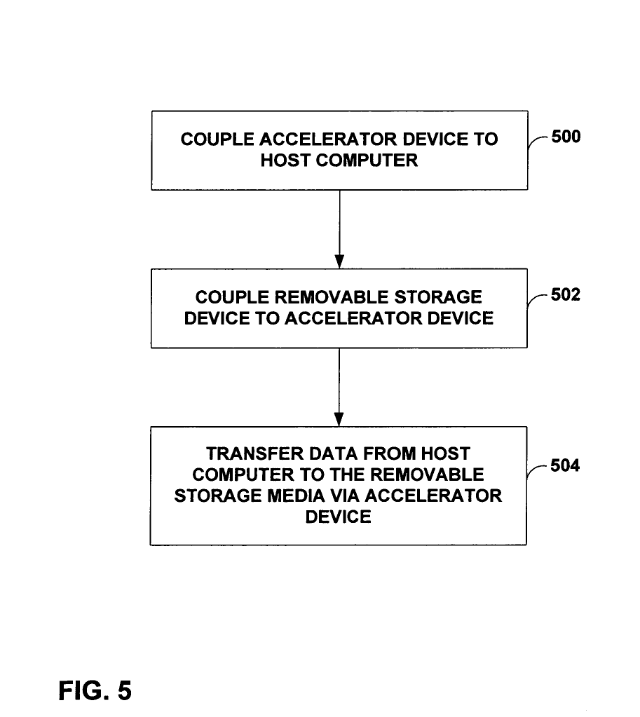

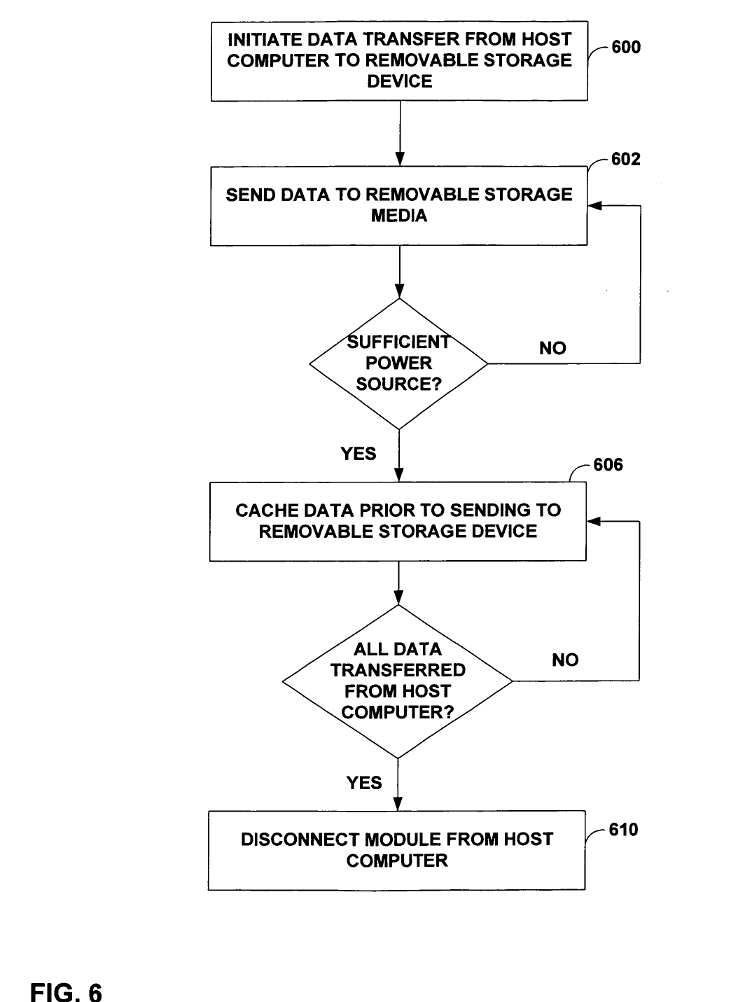

In some aspects, the present invention may be directed to a method for using an accelerator device such as those described herein. FIG. 5 is a flow chart illustrating an exemplary method according to an embodiment of the present invention. In this case, the exemplary method of FIG. 6 is described with reference to system 200 of FIG. 2, although the method may apply to other systems and devices, including those described herein. As illustrated by FIG. 5, a user may electrically couple accelerator device 202 to host computer 204 (500). The user may then electrically couple removable storage device 206 to accelerator device 202 (502), although a user may electrically couple removable storage device 206 to accelerator device 202 prior to coupling accelerator device 202 to the host computer 204. In general, the user may electrically couple accelerator device 202 to host computer 204 by connecting host computer connector 208 of accelerator device 202 to connector port 222 of host computer 204.

Similarly, the user may electrically couple accelerator device 202 to removable storage device 206 by connecting removable storage device connector 210 of the accelerator device 202 to cartridge connector 224 of removable storage device 206. Once host computer 204 and removable storage device 206 are electrically coupled to accelerator device 202, the user may send data from host computer 204 to removable storage device 206 via accelerator device 202 (504). When configured as such, accelerator device 202 may cache the data sent by host computer 204 prior to sending the data to removable storage device 206 to be written to the storage media of removable storage device 206.

FIG. 6 is a flow chart illustrating another exemplary method according to an embodiment of the present invention. The exemplary method illustrated in FIG. 6 may be used with embodiments of accelerator devices that include a power source, such as those described herein, that may provide sufficient energy to operate the accelerator device without requiring additional energy from the host computer. In this case, the exemplary method of FIG. 6 is described with reference to system 200 of FIG. 1, although the method may apply to other systems and devices, including those described herein. As indicated by FIG. 6, when host computer 204 and removable storage device 206 are electrically coupled via accelerator device 202, a transfer of data from host computer 204 to removable storage device 206 may be initiated (600). At that time, host computer 204 begins sending data to removable storage device 206 via accelerator device 202. Initially, accelerator device controller 212 sends the data received from host computer 204 to removable storage device 206 without caching the data. In addition, when accelerator device 202 begins to receive data from host computer 204, it determines whether the amount of energy stored in power source 214 is sufficient to operate accelerator device 202 without also receiving energy from host computer 204 (602).

If the amount of energy stored in the power source is determined to be insufficient, then controller 212 continues to send the data received from host computer 204 directly to removable storage device 206 (602). In such cases, power source 214 may be periodically or continually monitored to determine when the amount of energy stored in power source 214 becomes sufficient to operate accelerator device 202 without receiving energy from host computer 204, e.g., as a result of accelerator device 202 using the voltage supplied by host computer 204 to increase the amount of energy stored in power source 214.

When the amount of energy stored by power source 214 is sufficient, controller 212 causes the data received from host computer 204 to the cached in cache memory 216 prior to the data being sent to removable storage device 204 (606). The type of memory used for cache memory 216 allows the data received from host computer 204 to be cached at a greater speed than the data can be written to removable storage device 206. As further illustrated by FIG. 6, accelerator device 202 may continue to cache the data until all of the data has been received from host computer 204. At that time, all of the data will be either cached in cache memory 216 of accelerator device 202 or written to removable storage device 206. Accelerator device 202 may then be disconnected from host computer 204 (610) and the remaining cached data can be sent and written to removable storage device 206 using only the amount of voltage provided by accelerator device power source 214. Consequently, the exemplary method illustrated in FIG. 6 decreases the time required for host computer 204 to be electrically coupled to removable storage device 206 by utilizing accelerator device power source 214 to send the remaining cached data to removable storage device 206 without requiring additional energy from host computer 204.

Although the present disclosure describes the connectors of an accelerator device physically connecting directly to the corresponding removable storage device connectors and host computer connectors, embodiments are not limited to such configuration. For example, one or more connection adapters may be used to electrically couple an accelerator device to a removable storage device or host computer. As another example, one or more extension members may be used to connect the appropriate accelerator device connector to the corresponding connector of a host computer or removable storage device.

Furthermore, although the present disclosure primarily provides examples in which cache memory functions as a write cache, in some embodiments the cache memory may also function as a read cache. For example, a cache memory may be partitioned for read cache memory and write cache memory, either statically or dynamically. In such cases, data sent from a removable storage device to a host computer via an accelerator device to be read by host computer may be cached in cache memory prior to the data being read by the host computer. This data may be cached in the cache memory such that a host computer may read the data directly from the cache memory of the accelerator device rather than the removable storage device. Further, in some cases data cached in the write cache memory, e.g., data sent by a host computer to be written to a removable storage device, may be moved to a read cache after the data is written from the cache memory to the removable storage device.

Similar to the data write speeds described above, the speed that data can be read from a memory varies between the different types of memory. For example, data typically may be read from flash memory, DRAM, and SDRAM at a higher speed than that of a hard disk. Moreover, data typically may be read from DRAM and SDRAM at a higher speed than flash memory. Consequently, the speed at which data is read from cache memory by a host computer depends on the type of memory used for the cache memory. Similarly, the speed at which data may be read from the removable storage device by a host computer also depends on the type of memory used in the removable storage device.

Accordingly, in some embodiments, the type of memory used for a cache memory may allow data to be read by the host computer from the cache memory at a greater rate than data may be read by the host computer from the removable storage device. For example, an accelerator device that is configured to connect to a removable storage device that utilizes hard disk memory may include a cache memory that utilizes a memory type that allows data to be read at a speed greater than data can be read from the removable storage device, e.g., flash memory, DRAM or SDRAM. Consequently, such configurations may provide for an increase in the speed that data may be read from a removable storage device by the host computer via an accelerator device that includes a read cache memory. Although the first time that the data is read by the host computer it may be read directly from the removable device via the accelerator device, the data may also be cached in the cache memory at that time by the accelerator device. Accordingly, the host computer may read the data from the cache memory instead of the removable storage device any time subsequent to the first time the data is read by the host computer from the removable storage device via the accelerator device. In this manner, data from a removable storage device may be read by a host computer via an accelerator device at a greater rate than the data may be read by the host computer directly from the removable storage device.

Various embodiments of the invention have been described. These and other embodiments are within the scope of the following claims.

1. An accelerator device comprising:
a cache memory;
a controller electrically coupled to the cache memory;
a host computer connecter electrically coupled to the controller, wherein the accelerator device can be electrically coupled to a host computer via the host computer connector; and
a removable storage device connector electrically coupled to the controller, wherein a removable storage device can be electrically coupled to the accelerator device via the removable storage device connector,
wherein when the accelerator device is electrically coupled to the host computer and the removable storage device is electrically coupled to the accelerator device, the controller caches data sent from the host computer to the removable storage device in the cache memory prior to the data being sent from the accelerator device to the removable storage device.

2. The accelerator device of claim 1, wherein the host computer connector conforms to a connector standard selected from a group consisting of: a personal computer memory card international association (PCMCIA) standard, PC Card standard, a CardBus standard, a Universal Serial Bus (USB) standard, a Universal Serial Bus 2 (USB2) standard, an IEEE 1394 FireWire standard, a Small Computer System Interface (SCSI) standard, Serial Attached SCSI (SAS), an Advance Technology Attachment (ATA) standard, a serial ATA standard, a Peripheral Component Interconnect (PCI) standard, and a conventional serial or parallel standard.

3. The accelerator device of claim 1, wherein the removable storage device connector conforms to a connector standard associated with a removable storage device selected from a group consisting of: a Compact Flash standard, a Smart Media standard, a MultiMedia Card standard, a Secure Digital standard, a Memory Stick standard, an xD standard, Universal Serial Bus (USB) standard, a Universal Serial Bus 2 (USB 2) standard, a Small Computer System Interface (SCSI) standard, Serial Attached SCSI (SAS), an Advance Technology Attachment (ATA) standard, and a serial ATA (SATA) standard.

4. The accelerator device of claim 1, wherein the cache memory comprises at least one of flash memory, dynamic random access memory, and synchronous dynamic random access memory.

5. The accelerator device of claim 1, wherein data is written to the cache memory at a first rate and to the connected removable storage media device at a second rate, wherein the first rate is greater than the second rate.

6. The accelerator device of claim 1, wherein the removable storage device connector comprises a first removable storage device connector, the accelerator device further comprising a second removable storage device connector electrically coupled to the controller, wherein a first removable storage device can be electrically coupled to the accelerator device via the first removable storage device connector and a second removable storage device can be electrically coupled to the accelerator device via the second removable storage device connector.

7. The accelerator device of claim 6, wherein the first removable storage device is a different type than the second removable storage device.

8. The accelerator device of claim 1, further comprising an indicator element coupled to the controller that indicates to a user that a connected removable storage memory device may be safely removed.

9. The accelerator device of claim 1, further comprising a power source coupled to the controller that provides sufficient energy to operate the accelerator device without requiring additional energy from the host computer.

10. The accelerator device of claim 9, wherein the cache memory includes at least one of dynamic random access memory or synchronous dynamic random access memory.

11. The accelerator device of claim 9, wherein the power source stores an amount of voltage sufficient to allow the controller to send an amount of data stored in the cache memory to the removable storage device when the accelerator device is decoupled from the host computer.

12. The accelerator device of claim 11, wherein the amount of data is approximately equal to a maximum data capacity of the cache memory.

13. The accelerator device of claim 11, further comprising an indicator element that indicates when the power source contains the amount of voltage sufficient to allow the controller to send the amount of data stored in the cache memory to the removable storage device when the accelerator device is decoupled from the host computer.

14. The accelerator device of claim 11, wherein the power source includes an uninterruptible power supply (UPS).

15. The accelerator device of claim 14, wherein the UPS includes a capacitor capable of storing the amount of voltage sufficient to allow the controller to send an amount of data stored in the memory cache to the removable storage media device when the accelerator device is decoupled from the host computer.

16. The device of claim 1, further comprising an uninterruptible power supply (UPS) that defines a capacity that can store at least a sufficient voltage to allow the controller to send an amount of data stored in the cache memory to the removable storage device when the accelerator device is decoupled from the host computer, wherein:
when the UPS stores the sufficient voltage and the accelerator device is electrically coupled to the host computer and the removable storage device is electrically coupled to the accelerator device, the controller caches data sent from the host computer to the removable storage device in the cache memory prior to the data being sent from the accelerator device to the removable storage device; and
when the UPS does not store the sufficient voltage and the accelerator device is electrically coupled to the host computer and the removable storage device is electrically coupled to the accelerator device, the controller sends data sent from the host computer directly to the removable storage device.

17. The device of claim 1, wherein when the accelerator device is electrically coupled to the host computer and the removable storage device is electrically coupled to the accelerator device, the controller caches data sent from the removable storage device to the host computer in the cache memory prior to the data being sent from the accelerator device to the host computer.

18. The device of claim 17, wherein data is read by the host computer from the cache memory at a first rate and from the connected removable storage media device at a second rate, wherein the first rate is greater than the second rate.

19. A method comprising:
coupling an accelerator device to a host computer, the device comprising:
a cache memory;
a controller electrically coupled to the cache memory;
a host computer connecter electrically coupled to the controller, wherein the accelerator device can be electrically coupled to the host computer via the host computer connector; and
a removable storage device connector electrically coupled to the controller, wherein a removable storage device can be electrically coupled to the accelerator device via the removable storage device connector;
coupling the removable storage device to the accelerator device via the removable memory device interface; and
transferring data from the host computer to the removable storage media device via the accelerator device, wherein the controller caches data sent from the host computer to the removable storage device in the cache memory prior to the data being sent from the accelerator device to the removable storage device.

20. The method of claim 19, wherein the accelerator device further comprises a power source coupled to the controller, the method further comprising decoupling the accelerator device from the host computer after the data has been sent to either the memory cache or removable storage device but before the data has been completely sent to the removable storage media device, wherein the power source provides sufficient energy to complete the transfer of data from the memory cache to the removable storage device after the host computer has been decoupled from the accelerator device.

21. A system comprising:
a removable storage device; and
an accelerator device comprising:
a cache memory;
a controller electrically coupled to the cache memory;
a host computer connecter electrically coupled to the controller, wherein the accelerator device can be electrically coupled to a host computer via the host computer connector; and
a removable storage device connector electrically coupled to the controller, wherein the removable storage device can be electrically coupled to the accelerator device via the removable storage device connector,
wherein when the accelerator device is electrically coupled to the host computer and the removable storage device is electrically coupled to the accelerator device, the controller caches data sent from the host computer to the removable storage device in the cache memory prior to the data being sent from the accelerator device to the removable storage device.

22. The system of claim 21, further comprising the host computer.
